(19) United States
(12) Patent Application Publication
(10) Pub. No.: US 2010/0124041 A1
(43) Pub. Date: May 20, 2010

(54) SYSTEMS AND METHODS FOR CONTROLLING FLASH COLOR TEMPERATURE

(76) Inventor: VITALY DRUCHININ, Lynnwood, WA (US)

Correspondence Address: JENSEN & PUNTIGAM, P.S., 2033 SIXTH AVENUE, SUITE 1020, SEATTLE, WA, 98121-2527, US

(21) Appl. No.: 12/272,054

(22) Filed: Nov. 17, 2008

(51) Int. Cl. G03B 15/02

(52) U.S. Cl. 362/16

(57) ABSTRACT

An adjustable camera flash unit is provided, including a camera flash unit, and an adjustable light filter affixed in a light path of said camera flash unit. The adjustable light filter may be electronically adjustable when coupled to an appropriately configured electronic controller, and may be adjustable along a continuous range of color temperatures. By adjusting the adjustable light filter to a desired setting prior to discharging said camera flash unit, a flash of a desired color temperature is produced.

### BACKGROUND

Presently, camera flashes produce a flash of light at a factory-determined color temperature. Most flashes are designed to produce a color temperature corresponding to daylight, or about 5500 Kelvin. A flash at such a color temperature can produce undesirable effects on a photograph, however. For example, a photographer shooting on a cloudy day may specifically desire the more gray-blue ambient light quality of that particular day, and a “normal daylight” flash color temperature may interfere with this desired quality.

Undesirable effects from flash color temperature affect conventional photography as well as digital photography. Most digital cameras make use of an automatic white balance sensor. This sensor detects a predominant color temperature, and the camera then adjusts photographs to better match the detected predominant color temperature. Thus, the use of a flash with a given color temperature will often produce a predominant color temperature for the captured photograph, which will be further propagated into the photograph by the camera's electronics.

Photographers wishing for different flash color temperatures presently manually place filters in the light path between the flash and the subject. This is accomplished by purchasing and storing appropriate filters, and privately configuring means to hold a selected filter in the light path. This approach is inconvenient in the purchasing, storing, and organizing of multiple filters, the time needed to devise means for holding filters in place, and the additional photographer time required to select and position desired filters during a shoot. Moreover, the photographer is limited to the color temperatures produced by his unfiltered flash plus the specific color temperatures produced by filters in his possession.

The industry is in need of a better approach for controlling flash color temperature.

### SUMMARY

In consideration of the above-identified shortcomings of the art, the present invention provides systems and methods for controlling flash color temperature. An adjustable camera flash unit is provided which comprises a camera flash unit, and an adjustable light filter affixed in a light path of said camera flash unit. The adjustable light filter may be electronically adjustable when coupled to an appropriately configured electronic controller, and may be adjustable along a continuous range of color temperatures. By adjusting the adjustable light filter to a desired setting prior to discharging the camera flash unit, a flash of the desired color temperature is produced. An exemplary method of adjusting flash color temperature produced by a camera flash unit may thus include receiving a flash color temperature setting, and electronically adjusting a light filter affixed in a light path of said camera flash unit to produce the flash color temperature designated by said setting upon a flash of said camera flash unit. Other advantages and features of the invention are described below.

### BRIEF DESCRIPTION OF THE DRAWINGS

The systems and methods for controlling flash color temperature in accordance with the present invention are further described with reference to the accompanying drawings in which:

FIG. 1 illustrates a camera equipped with apparatus for controlling flash color temperature.

FIG. 2 illustrates an exemplary flash unit equipped with a liquid crystal adjustable light filter.

FIG. 3 illustrates an exemplary flash unit equipped with a moving adjustable light filter component.

FIG. 4 illustrates an exemplary microcomputer such as may be used as an electronic controller for an electronically adjustable light filter.

FIG. 5 illustrates a human interface for controlling an electronically adjustable light filter to produce a desired flash color temperature.

FIG. 6 illustrates component parts of a digital camera incorporating an adjustable light filter for controlling flash color temperature as provided herein.

FIG. 7 illustrates an exemplary method for controlling flash color temperature.

### DETAILED DESCRIPTION

Certain specific details are set forth in the following description and figures to provide a thorough understanding of various embodiments of the invention. Certain well-known details often associated with cameras and/or computing and electronics technologies are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

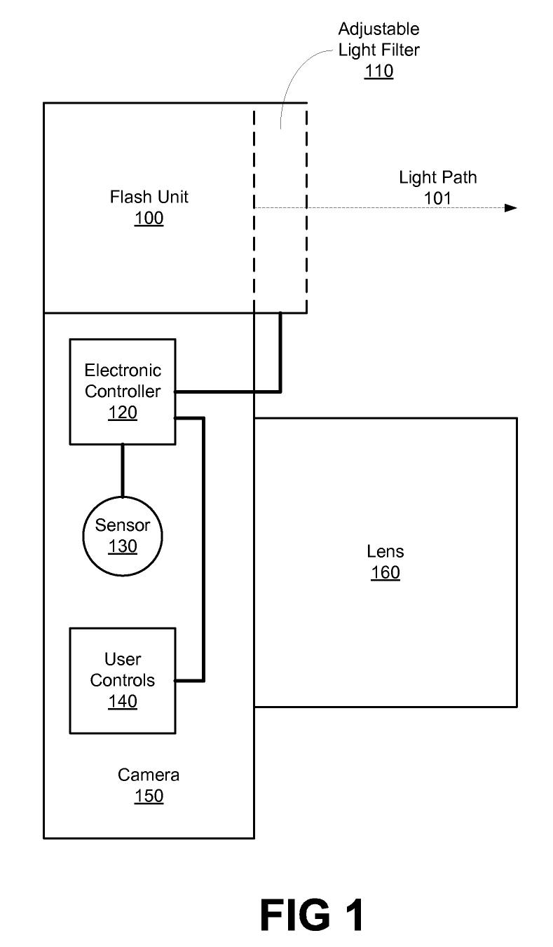

FIG. 1 illustrates a camera 150 equipped with an electronically adjustable camera flash unit for controlling flash color temperature according to one embodiment. Illustrated in FIG. 1 is a top view of camera 150 and lens 160 in a single-lens reflex type configuration, where camera 150 is equipped with internal flash unit 100. An adjustable light filter 110 is affixed in a light path 101 of said camera flash unit 100. The adjustable light filter 110 is communicatively coupled to an electronic controller 120 disposed inside the camera 150. The electronic controller 120 sets the filter color of the adjustable light filter 110 to a desired color temperature setting. This is accomplished by sending appropriate electronic signals to the adjustable light filter 110.

The electronic controller 120 may be communicatively coupled to input devices such as an ambient light sensor 130 and user controls 140. Input devices 130 and 140 provide a desired flash color temperature setting to the electronic controller 120, which in turn adjusts the adjustable light filter 110 to the desired setting. Various default settings may also be produced by electronic controller 120 without the need for an input setting.

While adjustable camera flash units comprising flash unit 100 and an adjustable light filter 110 may be incorporated into a camera 150 as an internal flash, as illustrated in FIG. 1, it should be emphasized that embodiments in which adjustable camera flash units are constructed as external flashes that are detachable from a camera body are also contemplated and fall within the scope of the invention. Similarly, some embodiments may decouple the camera 150 and flash unit 100 from the adjustable light filter 110, in which case the adjustable light filter 110 and optionally also the electronic controller 120, sensor 130, and user controls 140 can form a separate adjustable camera flash attachment. Such a separate, adjustable camera flash attachment arrangement may include an integrated electronic controller 120, sensor 130, and user controls 140, or may interface with a camera 150 or freestanding flash unit which supplies these elements.

In an internal flash configuration, the wiring connecting an electronic controller such as 120 with an adjustable light filter such as 110 in FIG. 1 may form a permanent, non-detachable connection, while in an external flash configuration, the wiring may be decouplable. For example, if electronic controller 120 is disposed inside a camera 150, while the flash unit 100 is an external unit, then the wiring attaching electronic controller 120 with the adjustable light filter 100 may be decouplable according to current techniques for configuring decouplable and re-coupleable external flash electronics, or indeed according to any of the presently available or future developed electronic communications interfaces such as Universal Serial Bus (USB), Peripheral Component Interface (PCI), and so on. A full list of all possible electronic interface types is not reproduced here but will be appreciated by those of skill in the art.

It should furthermore be noted that in still another advantageous embodiment, the flash unit 100 and adjustable light filter 110, as well as the electronic controller 120, sensor 130, and user controls 140 may all be disposed in an external flash, thereby eliminating the need for a decouplable connection between electronic controller 120 and the adjustable light filter 110, while simultaneously achieving an external flash configuration.

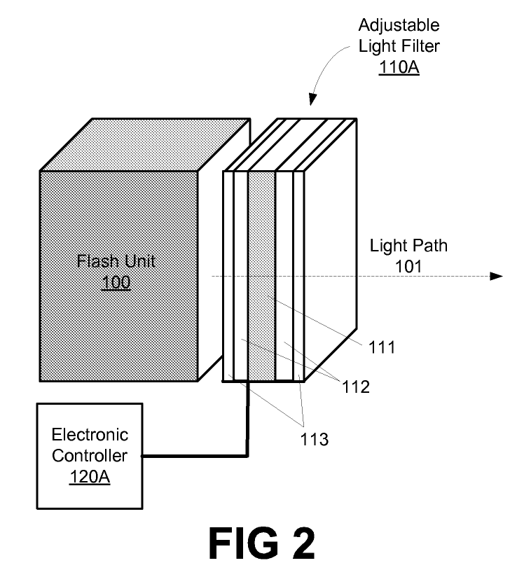

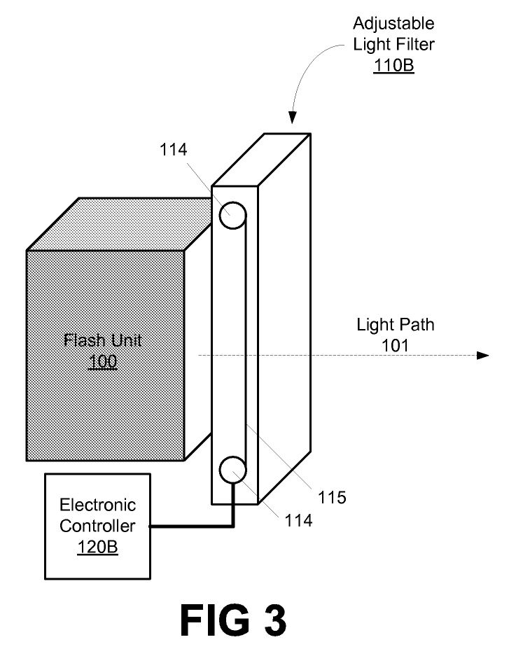

FIGS. 2 and 3 provide alternative exemplary embodiments of an adjustable camera flash unit. In FIGS. 2 and 3, the exemplary filters 110A and 110B are affixed in a light path 101 of the flash unit 100. In other words, filters 110A and 110B are affixed to either the flash unit 100 or to a structure attached to the flash unit 100, such as a camera 150; in such manner that light which emanates from the flash unit 100 upon discharge can pass through the filter.

The exemplary filters 110A and 110B may be affixed by a wide variety of techniques. A transparent adhesive may be used to glue the filters 110A and 110B in place. If adhesive is applied only around a perimeter of the filters 110A and 110B, the adhesive may be non-transparent. Alternatively, the filters 110A and 110B may replace the glass or plastic front pane that is normally built into flash units, and may be affixed using any of the approaches presently used or subsequently developed to affix such front panes in place. The filters 110A and 110B may be affixed using screws, rivets, snaps, suction cups, or magnets. The term “affixed” can thus be understood as either permanently or temporarily affixed. The filters 110A and 110B may also be simultaneously affixed and moveable, such as where a filter 110A is on a hinge and latch or ratcheting swivel and is thus moveable into and out of the light path 101.

The flash unit 100 may be constructed according to any of a wide variety of flash unit construction approaches. In general, camera flashes have evolved from the earliest flashes, created by a quantity of magnesium flash powder that was ignited by hand, toward today's predominantly electronic flash units. Today's flashes are often electronic xenon flash lamps. An electronic flash contains a tube filled with xenon gas, where electricity of high voltage is discharged to generate an electrical arc that emits a short flash of light. As mentioned above, today's flashes generally produce a single flash color temperature, which is a product of the light produced by the flash itself plus any reflective materials used on the internal housing of the flash, plus any filtering effect of the transparent material encasing the flash and through which the flash light must travel in the light path. While electronic flashes are common today, embodiments using other types of flash technologies such as microflash, Light Emitting Diode (LED) flashes, or indeed flashcubes and the like are also possible.

FIGS. 2 and 3 also demonstrate how in one embodiment, the adjustable light filter can form an adjustable camera flash attachment that is separate from camera 150 and flash unit 100. In such embodiments, the adjustable light filter 110A or 110B and optionally also the electronic controller 120 as well as any number of additional inventive aspects disclosed herein can form a separate, adjustable camera flash attachment. Such an attachment may be affixable to a camera or freestanding flash assembly to produce the desired color temperature control. The electronically adjustable camera flash attachment may include an internal ambient light sensor and/or human interface for controlling flash color temperature settings, or may interface to a camera and receive flash color temperature settings from the camera.

Referring now to FIG. 2 alone, an embodiment is illustrated in which a liquid crystal filter 110A is used. A liquid crystal filter 110A can be configured, generally speaking, as a Liquid Crystal Display (LCD) in which the flash unit 100 is the light source for the display.

In one embodiment, a liquid crystal filter 110A may comprise a layer of molecules 111 aligned between transparent electrodes 112 and polarizing filters 113, the axes of transmission of which may be nonparallel, such as by being oriented perpendicular to each other. The surface of the electrodes 112 that are in contact with the liquid crystal material 112 are treated so as to align the liquid crystal molecules in a particular direction. This treatment typically comprises unidirectionally rubbing a thin polymer layer on the surfaces of the electrodes 112 in contact with the liquid crystal 112. Electrodes 112 may be made of a transparent conductor, such as Indium Tin Oxide (ITO).

Before applying an electric field, the orientation of the liquid crystal molecules 111 is determined by the alignment at the surfaces. For example, the surface alignment directions at the two electrodes 112 may be perpendicular to each other, so the molecules arrange themselves in a helical structure. Light passing through one polarizing filter 113 (left side) is rotated by the liquid crystal helix as it passes through the liquid crystal layer 111, allowing it to pass through the second polarized filter 113 (right side). Thus when no voltage is applied across electrodes 112, the filter 110A is reasonably transparent.

When a voltage is applied across the electrodes 112, a torque acts to align the liquid crystal molecules 111 parallel to the electric field, distorting the helical structure. This reduces the rotation of the polarization of the incident light emanating from the flash unit 100. If the applied voltage is large enough, the liquid crystal molecules 111 are almost completely untwisted and the polarization of the incident light is not rotated as it passes through the liquid crystal layer 111. This light will then be mainly polarized perpendicular to the second filter 113 (right side), and thus be blocked. By controlling the voltage applied across the liquid crystal layer in each pixel of the filter 110A, light can be allowed to pass through in varying amounts.

To produce a desired color temperature, in one embodiment, each individual pixel of the filter 110A may be divided into three cells, or subpixels, which are colored red, green, and blue, respectively, by additional filters (e.g. pigment filters, dye filters and metal oxide filters). The voltage applied across each subpixel can be controlled independently by electronic controller 120A to yield thousands or millions of possible colors for each pixel. Color components may furthermore be arrayed in various pixel geometries, as is understood in the art of LCD manufacture.

The electronic controller 120A may employ LCD electronics to instruct the filter 110A to, for example, display a red color on all pixels. This may be for example a specific shade of red corresponding to a desired flash color temperature. The filter 110A is set to this color prior to discharge of the flash unit 100. Upon discharge, the filter will then absorb light of the undesired color temperatures, and allow light of the desired color temperature to pass through. As LCDs are capable of displaying light across the entire range of the visible spectrum, the liquid crystal filter 110A is likewise capable of filtering to any desired color temperature across the entire visible spectrum.

FIG. 2 illustrates the best mode presently contemplated for the adjustable light filter, however FIG. 3 is included herein to demonstrate that alternative arrangements are feasible in any number of configurations that could be arrived at by those of skill in the art with the benefit of the teachings herein. FIG. 3 illustrates a flexible filter material 115 such as a plastic ribbon with a variety of different filter colors along its length. Electronically activated rollers 114 can serve to advance and retract the material 115 to situate a desired filter color in the light path 101. The movement of rollers 114 can be under the control of electronic controller 120B. Controller 120B may thus for example cause a red-colored filter material corresponding to a desired flash color temperature to be situated in light path 101.

The electronic controller illustrated as 120 in FIG. 1, 120A in FIG. 2, and 120B in FIG. 3, may comprise electronics of any configuration suitable to receive a desired input flash color temperature setting, and to generate appropriate electronic signals that cause an adjustable light filter to produce the input flash color temperature setting. Many if not most of today's cameras contain multifunction microcomputers; one contemplated embodiment for electronic controller 120 is that of a microcomputer equipped to perform the flash color temperature control functions described herein, along with any other functions otherwise performed by such microcomputer.

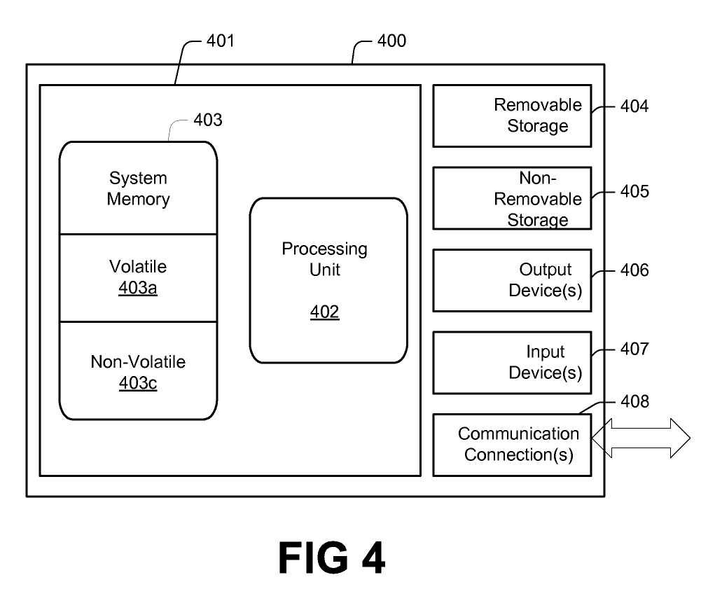

While computing and software technologies are constantly and rapidly evolving, FIG. 4 illustrates an exemplary computing device 400, e.g., a camera, equipped with a suitable processing core 401 that may be used as an electronic controller 120. In its most basic configuration, processing core 401 typically includes a processing unit 402 and memory 403. Depending on configuration, memory 403 may be volatile (such as RAM), non-volatile (such as ROM, flash memory, etc.) or some combination of the two. Memory 403 contains software instructions that dictate device 400 behaviors. For example, memory 403 may contain instructions for receiving a color temperature input setting (from a user via a user interface, from a sensor or other electronic device, or as a default value), and instructions for controlling an adjustable filter to produce the input color temperature setting.

Additionally, device 400 may also have mass storage (removable 404 and/or non-removable 405) such as flash memory or magnetic or optical disks. Device 400 may also have input devices 407 such as camera user interface buttons, connected computing devices, or a touch-screen input, and/or output devices 406 such as a display that presents a GUI as a graphical aid accessing the functions of the computing device 400. Other aspects of device 400 may include communication connections 408 to other devices, computers, networks, servers, etc. using either wired or wireless media.

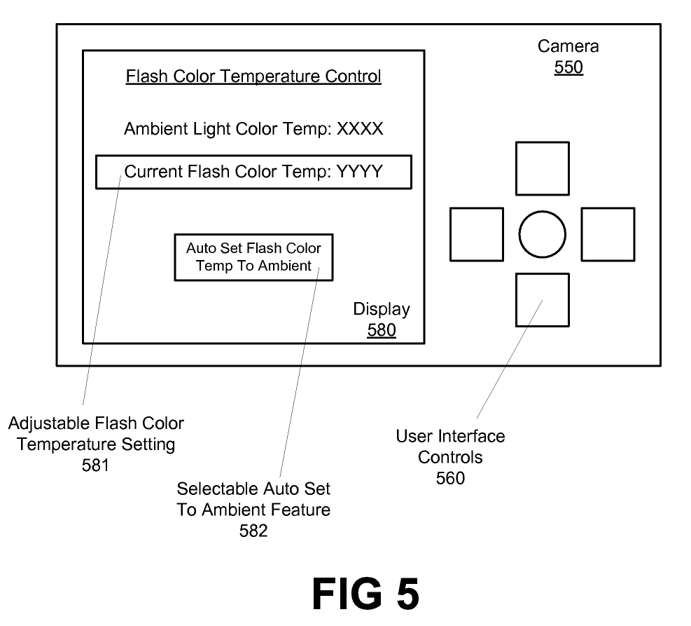

FIG. 5 illustrates a human interface as may be included for example on the back side of a camera 550. Such an interface may alternatively be included on an external flash, or other device incorporating an adjustable flash unit. The human interface comprises controls 560 and a display 580, allowing a human to control an electronically adjustable light filter input setting to cause the electronic controller 120 to produce a desired flash color temperature. In the exemplary embodiment of FIG. 5, display 580 presents a current ambient light color temperature, denoted as XXXX. For example, if camera 550 is equipped with an ambient light color sensor, the retrieved sensor value may be displayed here.

Exemplary display 580 furthermore presents an adjustable flash color temperature setting 581, denoted as YYYY. This color temperature setting will be sent to the electronic controller 120 as an input setting. By for example pressing the top and/or right button of user interface controls 560, the user can increase the setting 581, and by pressing the bottom and/or left button of user interface controls 560, the user can decrease the setting 581. It will be appreciated that the setting 581 may be converted to an input to the electronic controller 120 either each time the setting 581 is changed, or upon another event such as the user pressing the center button of user interface controls 160, or the user navigating away from the flash color temperature control screen.

Finally, a feature may be provided whereby the adjustable flash color temperature setting 581 can be automatically set to substantially match an ambient light color temperature retrieved from an ambient light sensor. For example, by navigating to the selectable auto set to ambient feature 582, and depressing the center button of user interface controls 560, the adjustable flash color temperature setting 581 can be set to equal the ambient light color temperature (XXXX).

Once the auto set to ambient feature 582 is selected, the adjustable flash color temperature setting 581 can subsequently be automatically reset to ambient just prior to capturing subsequent photographs, to account for changes in ambient light color temperature between photograph captures. Alternatively, the adjustable flash color temperature setting 581 can be updated periodically, such as by subsequently checking the ambient light color temperature at predetermined time intervals, resetting the setting 581 to match, and sending this input to the electronic controller 120. In yet another embodiment, setting to ambient 582 may be a one-time operation, requiring a user to go back to the flash color temperature control screen and re-select the auto set to ambient feature 582.

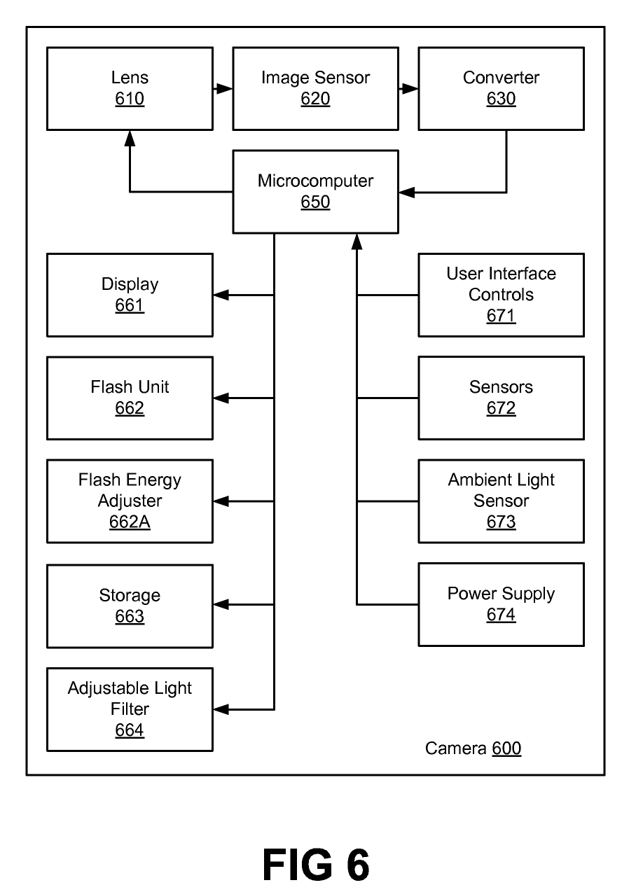

FIG. 6 illustrates component parts of a digital camera 600 incorporating an adjustable light filter 664 for controlling flash color temperature as provided herein. In general, camera 600 is illustrated in a digital camera embodiment in which light collected through a lens 610 falls on an image sensor 620, is converted to an electric signal by converter 630, and processed by microcomputer 650. Microcomputer 650 operates according to inputs received from elements on the right hand side of FIG. 6, and controls outputs to elements on the left side of FIG. 6. Microcomputer may also control lens 610 to some extent, such as in carrying out zoom functions and the like.

Microcomputer 650 may receive power from a power supply 674 such as a battery, and may store photographs in a storage 663 such as a fixed or removable flash memory, or any of the wide variety of other storage media available for digital cameras.

Microcomputer 650 may receive user inputs from user interface controls 671, and may change camera settings, operate camera hardware, and support user interaction via the display 661 according to the received user inputs. User interface controls 671 may include for example the control buttons 560 illustrated in FIG. 5, as well as features such as zoom, focus, flash mode selections, photo navigation and viewing functions, a shutter button, and so forth.

One hardware component that may be controlled by the microcomputer 650 according to settings established by the user is the flash unit 662. Flash unit 662 may discharge according to desired settings when the user depressed the camera's shutter button. Settings that may govern flash unit 662 operation are whether the flash 662 is in automatic mode in which flash triggers automatically, red-eye reduction mode which fires the flash several times just prior to exposing a photo, forced (fill-in) flash mode which keeps the flash on in situations where automatic mode would keep it off, suppressed flash mode which turns the flash off, slow sync mode which captures a dimly lit background at night by firing briefly to light the foreground subject, rear-curtain sync mode which is similar to slow sync, but the flash doesn't fire until just before the shutter closes, and flash exposure compensation mode which increases or decreases the energy output of the flash.

Flash energy adjuster 662A may be a separate component or may be formed by appropriately configuring the microcomputer 650. The role of the flash energy adjuster 662A is to adjust flash energy to accommodate for flash energy attenuation at a flash color temperature setting.

Different color temperature settings at the adjustable light filter will absorb different amounts of light energy. In other words, they will result in different amounts of flash energy attenuation. For example, a light blue filter will allow more flash energy to pass through to the photographed subject than a dark blue filter. Similar effects will be experienced across the color spectrum, with different shades affecting the amount of flash energy as well as flash color temperature. This difference in flash energy affects the exposure of the resulting photograph, and if not accommodated, could lead to a photograph being over- or underexposed due to a color temperature setting at the adjustable light filter.

To accommodate for flash energy attenuation at a given flash color temperature setting, the flash energy adjuster 662A can increase or decrease flash energy based at least in part on flash color temperature. In one embodiment, this can be done using a look-up table that correlates various color temperature ranges with corresponding flash energy modification needs. For example, if a particular flash color temperature setting will absorb 60% of flash energy, the look-up table might specify that the flash energy that would otherwise be used, e.g., in the absence of the adjustable flash filter, should be increased by 60%. The flash energy adjuster 662A can thus first determine the adjustable flash filter's color temperature setting, and then look up a corresponding modification of flash energy. A final flash energy can be determined after accounting for any other flash compensation needs. The flash energy adjuster 662A can set the energy of the flash unit to the final flash energy for example by allowing a flash capacitor to accumulate appropriate charge prior to discharging the flash unit.

Existing flashes use exposure compensation modes to adjust flash energy to account for a distance from the flash unit to a subject, and this may also be taken into account by the flash energy adjuster 662A or by separate apparatus as appropriate. Techniques for adjusting flash energy based on subject distance include “Through The Lens” or TTL approaches in which subject distance is inferred from a lens focus setting, and pre-flash approaches that discharge an initial flash and measure the time for light to bounce back. Either of these techniques or other developed techniques for flash energy compensation based on subject distance may be used in conjunction with the techniques for flash energy compensation based on a color temperature setting disclosed herein.

The flash energy adjuster 662A may also respond to settings entered at the user interface controls 671, and may generate warnings or other information to be displayed on the display 661. For example, flash energy adjuster 662A may allow for manually setting a desired flash energy. The user may be presented with options such as “½ power,” “¼ power,” and the like, expressing flash energy as a fraction of total available energy, or with actual flash energy units such as “30 Watt-Seconds,” “60 Watt-Seconds” and the like.

The flash energy adjuster 662A may send warnings to the display 661 when the flash unit does not have enough power to produce a desired target exposure level. This situation could arise for example if a subject is both far away, and a desired flash color temperature absorbs much of the flash energy. The warning may allow the user to take certain pre-set response actions, for example change the flash color temperature setting to allow target exposure, or take the photograph anyway. The user may also set defaults via the user interface controls 671 to handle the out-of-range issue.

Microcomputer 650 may receive inputs a variety of sensors 672 that are used to collect information about ambient conditions for display to a user or for automatic settings adjustments. An ambient light sensor 673 may detect an ambient light color temperature. This value can be supplied this as an input to microcomputer 650, which may subsequently display the retrieved value, discard the retrieved value, use the retrieved value as a setting for the adjustable light filter 664, or use the retrieved value as an input to a formula for determining a setting for the adjustable light filter 664. In the case of using the retrieved value as an input to a formula, the microcomputer 650 may for example be instructed to set the adjustable light filter 664 to a color temperature that is, for example, just redder than ambient, just bluer than ambient, or the like, to produce a desired photographic effect.

In one embodiment, the ambient light sensor 673 may be situated inside the camera 600 such that light introduced through lens 610 falls partially upon the sensor 673, and therefore the sensor 673 detects ambient light color temperature in a direction corresponding to a would-be subject of a photograph. Embodiments are also feasible in which existing camera 600 components such as the lens 610, image sensor 620, converter 630 and microcomputer 650 are configured to operate as an ambient light color temperature sensor—eliminating the need for including additional hardware such as 673 in the camera 600.

Microcomputer 650 may furthermore serve as an electronic controller (e.g. element 120 from FIG. 1) for an adjustable light filter 664. In this regard, microcomputer 650 may use an appropriate setting received from the user via 671 or from the ambient light sensor 673 to adjust the adjustable light filter 664 so as to produce the color temperature of the setting upon discharge of the flash unit 662. In general, such adjusting comprises sending appropriate electronic signals to the adjustable light filter 664 prior to any discharge of the flash unit 663. These signals will vary depending on the type of filter used as will be appreciated.

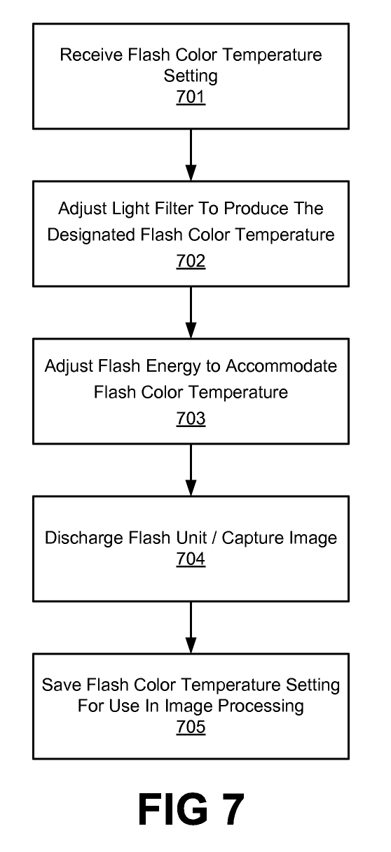

FIG. 7 illustrates an exemplary method as may be carried out in accordance with various embodiments of the invention, for example by an electronic controller that adjusts flash color temperature. Such a controller may first receive a flash color temperature setting 701. The setting may be received by virtue of being “pushed” to the electronic controller 120 or by being “pulled” such as where a sensor 673 is polled, or a computer memory is read in order to retrieve a default setting.

The received setting may then be used to adjust a light filter to produce the designated flash color temperature 702. The details of performing this operation will vary with the specific electronics of individual embodiments. For example, in a liquid crystal filter embodiment, appropriate commands for LCD type electronics will generate electronic signals that produce a desired color in the liquid crystal filter.

Flash energy may then be adjusted 703 to account for the designated flash color temperature, as well as subject distance or other factors affecting flash energy.

The flash unit may then be discharged 704 in connection with taking a photograph. The flash color temperature setting may also be saved, for example as metadata with the captured photograph, for use in subsequent image processing 705.

In light of the diverse embodiments that may be built according to the general framework provided herein, the disclosed systems and methods cannot be construed as limited to a particular architecture. Instead, the invention should be construed in breadth and scope in accordance with the appended claims.

1. An electronically adjustable camera flash unit, comprising:
a camera flash unit;
an electronically adjustable light filter affixed in a light path of said camera flash unit, said electronically adjustable light filter modifying a flash color temperature produced upon discharge of said camera flash unit.

2. The electronically adjustable camera flash unit of claim 1, further comprising an electronic controller coupled to said electronically adjustable light filter, said electronic controller further coupled to an ambient light sensor.

3. The electronically adjustable camera flash unit of claim 2, wherein said electronic controller automatically adjusts said electronically adjustable light filter to produce a flash color temperature substantially matching an ambient light color temperature.

4. The electronically adjustable camera flash unit of claim 1, further comprising an electronic controller coupled to said electronically adjustable light filter and a human interface for controlling flash color temperature via said electronic controller.

5. The electronically adjustable camera flash unit of claim 1, wherein said electronically adjustable light filter is adjustable along a continuous range of color temperatures.

6. The electronically adjustable camera flash unit of claim 1, wherein said electronically adjustable light filter comprises a liquid crystal light filter.

7. The electronically adjustable camera flash unit of claim 1, wherein said camera flash unit is housed in a camera as an internal flash and said electronically adjustable light filter is affixed to said camera.

8. The electronically adjustable camera flash unit of claim 1, further comprising a flash energy adjuster, said flash energy adjuster adjusting flash energy to accommodate for flash energy attenuation at a flash color temperature setting.

9. A continuously adjustable camera flash unit, comprising:
a camera flash unit;
an adjustable light filter affixed in a light path of said camera flash unit, wherein said adjustable light filter is adjustable along a continuous range of color temperatures.

10. The continuously adjustable camera flash unit of claim 9, wherein said adjustable light filter comprises a moving filter component.

11. The continuously adjustable camera flash unit of claim 10, further comprising an ambient light sensor and a display, the display indicating an ambient light color temperature measured by said ambient light sensor.

12. The continuously adjustable camera flash unit of claim 9, further comprising a flash energy adjuster, said flash energy adjuster adjusting flash energy to accommodate flash energy attenuation at a flash color temperature setting.

13. A method of adjusting flash color temperature produced by a camera flash unit, comprising:
receiving a flash color temperature setting at an electronic controller;
said electronic controller electronically adjusting a light filter affixed in a light path of said camera flash unit to produce a flash color temperature designated by said flash color temperature setting upon a flash of said camera flash unit.

14. A method according to claim 13, wherein said flash color temperature setting is received from a user interface.

15. A method according to claim 13, wherein said flash color temperature setting is received from an ambient light sensor.

17. A method according to claim 13, wherein said light filter comprises a liquid crystal light filter.

18. A method according to claim 13, further comprising adjusting flash energy to accommodate flash energy attenuation at said flash color temperature setting.

19. An electronically adjustable camera flash attachment for adjusting a color temperature produced by a camera flash unit, comprising:
an electronically adjustable light filter affixable in a light path of said camera flash unit; and
an electronic controller that receives a flash color temperature setting and electronically adjusts said electronically adjustable light filter to said flash color temperature setting.

20. The electronically adjustable camera flash attachment of claim 19, further comprising an ambient light sensor coupled to said electronic controller, said electronic controller receiving said flash color temperature setting from said ambient light sensor.

21. The electronically adjustable camera flash attachment of claim 19, further comprising a human interface coupled to said electronic controller, said electronic controller receiving said flash color temperature setting from said human interface.

22. The electronically adjustable camera flash attachment of claim 19, further comprising a camera interface coupled to said electronic controller, said electronic controller receiving said flash color temperature setting from said camera interface.
